(19) United States
(12) Patent Application Publication
(10) Pub. No.: US 2021/0262988 A1
(43) Pub. Date: Aug. 26, 2021

(54) AUTOMATED RESONANCE TEST ON MULTI-COMPONENT COMPONENTS BY MEANS OF PATTERN RECOGNITION

(71) Applicant: Siemens Energy Global GmbH & Co. KG, Munich, Bayern (DE)

(72) Inventors: Ingo Balkowski, Kerken (DE); Ralf Bell, Mülheim an der Ruhr (DE); Uwe Pfeifer, Berlin (DE)

(73) Assignee: Siemens Energy Global GmbH & Co. KG, Munich, Bayern (DE)

(21) Appl. No.: 17/261,673

(22) PCT Filed: Jul. 9, 2019
(86) PCT No.: PCT/EP2019/068369

§ 371 Date: Jan. 20, 2021

(30) Foreign Application Priority Data
Aug. 10, 2018 (DE) 10 2018 213 475.8

(51) Int. Cl. G01N 29/12; G10L 25/51; H04R 1/08; G01N 29/44; G06N 20/00; G06N 5/04

(52) U.S. Cl. CPC G01N 29/12; G10L 25/51; H04R 1/08; G01N 2291/023; G06N 20/00; G06N 5/04; G01N 2291/014; G01N 29/4472

(57) ABSTRACT

A method for performing a resonance test on a multicomponent component wherein fast and simple classification of the state of the component is ensured by carrying out the resonance test in an automated manner on blade assemblies, in which frequency images of new and used components are compared with each other. For performing a resonance test by direct mechanical excitation of a multicomponent component in the initial state, relevant acoustic parameters of the airborne sound are determined or are numerically computed and deposited in a database. The method includes performing an excitation of a component after use in order to produce structure-borne vibrations in the component and the airborne sound resulting therefrom, measuring the airborne sound by a spaced-apart microphone, determining the relevant acoustic parameters, wherein this is compared with the initial state, and deviations are detected.

### CROSS REFERENCE TO RELATED APPLICATIONS

This application is the US National Stage of International Application No. PCT/EP2019/068369 filed 9 Jul. 2019, and claims the benefit thereof. The International Application claims the benefit of German Application No. DE 10 2018 213 475.8 filed 10 Aug. 2018. All of the applications are incorporated by reference herein in their entirety.

### FIELD OF INVENTION

The invention relates to the automated performance of resonance tests on multicomponent components, such as blade assemblies, in which patterns are recognized.

### BACKGROUND OF INVENTION

In steam turbines and also in compressors as well as in gas turbines, individual rows of blades are connected by means of blade base and cover band. A fixed assembly thus results, which is insensitive to vibration excitation from the flow medium. The assembly can loosen in the course of operation, whereby blade damage, damage to adjoining components and power losses can result. Presently, the individual components are disassembled to inspect the blade assembly. The evaluation is carried out by means of hammer strike on the assembly and subjective evaluation by means of sound. The sound results from the acoustic processing by the human auditory system.

The subjective evaluation, which is possibly subject to error, on the one hand, and the time-consuming disassembly of the components, on the other hand, are problematic.

### SUMMARY OF INVENTION

The object is achieved by a method as claimed and a device as claimed.

The dependent claims list further advantageous measures, which can be combined with one another as desired to achieve further advantages.

### BRIEF DESCRIPTION OF THE DRAWINGS

FIGS. 1, 2 and 3 show patterns of the measurements by means of the resonance test,

FIG. 4 shows a component that can be used to perform a resonance test and a measuring arrangement for performing the resonance test.

### DETAILED DESCRIPTION OF INVENTION

The description and the figures only represent exemplary embodiments of the invention.

Essentially, this relates to supplying the sound of a new component or a technically authorized component, in particular a blade row, to a pattern recognition. For this purpose, the sound firstly has to be associated with a blade row. Upon direct excitation of the blade row, for example by means of hammer strike, the exact airborne sound and the relevant frequency pictures determined thereby can be associated directly with the blade row. Upon excitation of a bladed shaft or bladed housing at any arbitrary point, in particular by means of hammer strike, and measurement of the structure-borne noise at another arbitrary point, the assignment of the measured signals to a blade row is problematic. However, this problem can be solved by individual measurement during the new manufacturing. The frequency pictures of the new state are stored in a database and are considered to be so-called blueprints. These blueprints are supplied to a pattern recognition and assigned as a “healthy” blade row. Alternatively, the frequency pictures of new components can also be numerically computed by means of finite element methods.

Noteworthy characteristics of the sound such as the chronological change of the frequencies, the frequency profile and the decay behavior, can also be determined. Other characteristics of the acoustic analysis methods can also be used.

In the case of the measurement of the structure-borne noise on a used component, the signals are correspondingly analyzed and supplied to the pattern recognition.

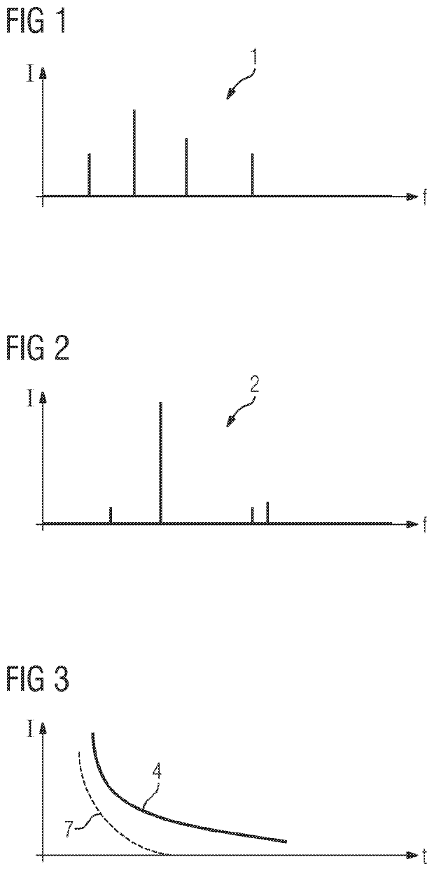

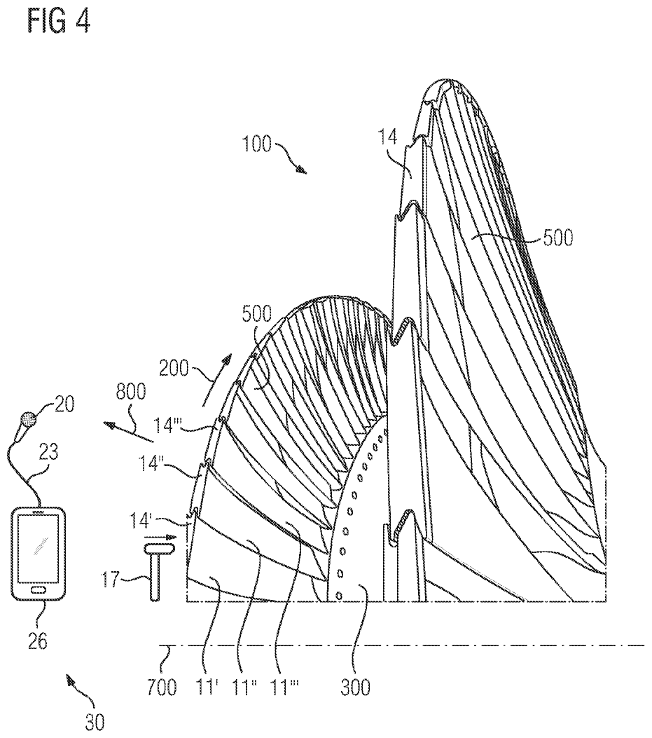

FIG. 1 shows a frequency picture 1 of a component 100 (FIG. 4) in the new state or before the first use. The intensity I is plotted in relation to the frequency f.

Various frequencies, which are not necessarily discrete, having various intensities are recognizable, which are typical for a new component. This is only one example of an acoustic parameter.

A frequency picture 2 of a component 100 after use according to FIG. 1 can be seen in FIG. 2.

Both the intensity I and also the location of the frequencies f have at least partially changed and/or shifted.

The decay behavior of the intensity I over the time t has a similar appearance, wherein a decay behavior 4 for new components is shown in FIG. 3 and the curve 7, shown by a dashed line here, represents the decay behavior of a used component. The decay behavior 4, 7 is only one example of an acoustic parameter.

This makes it clear that differences are provided which can be analyzed.

The pattern recognition recognizes in this case the deviation from the target state and assigns the blade rows as a component to a further classification such as “acceptable” or “to be replaced”. These classifications are established beforehand on the basis of preliminary studies and existing measurements.

FIGS. 1, 2, 3 depict illustrative patterns that can be produced from the recordings of the airborne sound.

To carry out the pattern recognition, inter alia, methods of artificial intelligence are applied.

FIG. 4 shows a detail from a blade assembly 100. The blade assembly 100 comprises multiple blades 11′, 11″, 11′″, in the form of turbine rotor blades, arranged on a rotor 300 in the circumferential direction 200. For the sake of clarity, only three turbine rotor blades are provided with the reference sign 11′, 11″, 11′″. The turbine rotor blades essentially comprise a rotor blade leaf 500 formed between a cover plate 14 and a blade base, which is not depicted in more detail. The rotor blade leaf 500 is designed such that a flow in the direction of the axis of rotation 700 containing a thermal energy is deflected such that the thermal energy is converted into rotational energy of the rotor 300. To this end, the rotor blade leaf 500 is profiled. The cover plates 14′, 14″, 14′″ are arranged behind one another in the circumferential direction 200.

The cover plates 14′, 14″, 14′″, . . . are in the form of Z-plates in this instance. The blade base not depicted in more detail is in the form of a hammer base. The cover plates 14′, 14″, 14′″, . . . are arranged on the rotor 300 such that one cover plate 14′, 14″, 14′″, . . . exerts a force on an adjacent cover plate 14′, 14′, 14′″, . . . . The cover plates 14′, 14′, 14′″, . . . are therefore pretensioned against one another.

During operation the rotor 300 rotates about the axis of rotation 700 at a frequency of between 25 Hz and 60 Hz. Higher frequencies are also possible. At these frequencies a centrifugal force occurs that causes the rotor blades 11′, 11″, 11′″, . . . to move in the radial direction 800, this being prevented by the blade base, which is held in a groove in the rotor 300. The radial direction 800 in this instance points from the axis of rotation 700 essentially along the longitudinal formation of a rotor blade 11′, 11″, 11′″, . . . . During operation, i.e. while a centrifugal force arises as a result of the rotation frequency, the rotor blades 11′, 11″, 11′″, . . . , pull away, leading to the pre-tension being amplified. This pulling-away takes place in a suitable direction that is embodied as an axis of rotation relative to the radial direction 800.

FIG. 4 also shows the performance of the resonance test by means of a mechanical excitation, e.g. of a hammer 17, which can be controlled manually or by a pulse generator and can be performed directly.

The component 100 is a blade assembly, wherein a cover band 14′, 14″, 14′″, . . . of a turbine blade 11′, 11″, 11′″, . . . is excited here, that is to say advantageously only one component of the multicomponent component (100).

This produces structure-borne vibrations within the installed component, as a result of which airborne sound vibrations are indirectly also produced in the air outside the component, these being captured and recorded by means of a microphone 20 that is not in contact with the component 14.

The microphone 20 is commercially available and converts the measured sound vibrations directly into electronic data.

The electronic data are transmitted by means of a cable 23 or other type of transmission to a cellphone or mobile electronic device 26 that has a program or an app by means of which the electronic data can be captured and analyzed and a recommendation and report can be output directly to a service engineer.

The advantages are: a) unambiguous assignment of defective components, including multicomponent components, by means of an objective method. b) avoidance of the disassembly of the component, which means a saving in costs and time and results in availability improvement.

1. A method for performing a resonance test on a multicomponent component or a blade assembly, the method comprising:
beforehand either relevant acoustic parameters in an initial state are determined by direct mechanical excitation of a multicomponent component in the initial state, wherein a microphone is used to measure the airborne sound thus produced, wherein the relevant acoustic parameters of the airborne sound comprise frequency pictures and/or frequency profiles and/or decay behavior or other acoustic characteristics, or the relevant acoustic parameters in the initial state comprising frequency pictures and/or frequency profiles and/or decay behavior are numerically computed, wherein the relevant acoustic parameters in the initial state are or have been deposited in a database, and
performing an excitation, of a component after use in order to produce structure-borne vibrations in the component and the airborne sound resulting therefrom,
measuring the airborne sound by means of a spaced-apart microphone,
determining the relevant acoustic parameters of the component after use, comprising frequency pictures and/or frequency profiles and/or decay behavior,
comparing the relevant acoustic parameters of the component after use with the relevant acoustic parameters of the component in the initial state, which is stored in the database, and
detecting deviations.

2. A device for a resonance test on a component or a blade assembly, the device adapted for performing the method as claimed in claim 1, the device comprising:
means, for recording acoustic parameters comprising frequency pictures and/or frequency profiles and/or decay behavior, which can be assigned to a component in the initial state, or means for numerically computing the relevant acoustic parameters in the initial state, comprising frequency pictures and/or frequency profiles and/or acoustic behavior,
a database, in which for storing these acoustic parameters in the initial state,
wherein an excitation, on the same component after use is performed, and
wherein acoustic parameters, comprising frequency pictures and/or frequency profiles and/or decay behavior, are recordable,
wherein these acoustic parameters are also stored and are compared with the existing acoustic parameters, comprising frequency pictures and/or frequency profiles, of the new component.

3. The method as claimed in claim 1,
wherein the recordings of the airborne sound are or can be converted by the microphone into acoustic parameters for evaluation.

4. The method as claimed in claim 1,
wherein methods of artificial intelligence are or can be applied to perform pattern recognition to detect deviations.

5. The method as claimed in claim 1,
wherein the detected deviations are or can be classified, between acceptable and to be replaced.

6. The method as claimed in claim 1,
wherein the component is an installed turbine blade assembly of turbine blades with cover bands,
wherein only one component of the multicomponent component is excited.

7. The method as claimed in claim 6,
wherein a cover band,
or a cover band of a turbine blade assembly, is or can be mechanically excited.

8. The method as claimed in claim 1,
wherein a microphone records or can record the airborne sound vibrations and
wherein the microphone electronically converts or can electronically convert the airborne sound vibrations and transmits or can transmit the airborne sound vibrations to a mobile device by means of a cable or wireless transmission for the purpose of evaluation,
wherein the mobile device analyzes or can analyze the recordings of the microphone in electronic form.

9. The method as claimed in claim 1, further comprising:
connecting or coupling a mobile device to the microphone electronically.

10. The method as claimed in claim 1,
wherein the microphone converts or can convert the airborne sound measurements into an electronic form.

11. The method as claimed in claim 1,
wherein the multicomponent component in the initial state comprises a new multicomponent component.

12. The method as claimed in claim 1,
wherein the excitation comprises a mechanical excitation.

13. The method as claimed in claim 1,
wherein the deviations are evaluated.

14. The device as claimed in claim 2,
wherein the means for recording comprises a microphone.

15. The device as claimed in claim 2,
wherein the excitation comprises a mechanical excitation.
